(19) United States
(12) Patent Application Publication
(10) Pub. No.: US 2026/0048812 A1
(43) Pub. Date: Feb. 19, 2026

(54) ADJUSTABLE SUSPENSION LOWERING SYSTEM

(71) Applicant: Stoney Craig Harris, Midland, TX (US)

(72) Inventor: Stoney Craig Harris, Midland, TX (US)

(21) Appl. No.: 19/301,773

(22) Filed: Aug. 15, 2025

Related U.S. Application Data
(60) Provisional application No. 63/684,104, filed on Aug. 16, 2024.

(51) Int. Cl. B62K 25/04

(52) U.S. Cl. CPC B62K 25/04; B62K 2025/045

(57) ABSTRACT

Apparatus and associated methods relate to a motor vehicle suspension lowering apparatus and system. In an illustrative example, the motor vehicle suspension lowering apparatus may, for example, include one or more curved mounting brackets. The one or more curved mounting brackets may, for example, operatively couple an existing rear suspension and shock mounts of a motor vehicle. The one or more curved mounting brackets may, for example, operatively couple one or more linking brackets via fastening elements inserted into corresponding predetermined apertures on both the one or more linking brackets and the one or more mounting brackets. Various embodiments may advantageously alter a geometry of an existing rear suspension of a motor vehicle to selectively lower a rear ride height of the motor vehicle.

### CROSS-REFERENCE TO RELATED APPLICATIONS

This application is a non-provisional application and claims the benefit of U.S. Application Serial No. 63/684, 104, titled “Aftermarket rear lowering kit for Yamaha PW50 dirt bike,” filed by Stoney Craig Harris on Aug. 16, 2024.

This application incorporates the entire contents of the foregoing application(s) herein by reference.

### TECHNICAL FIELD

Various embodiments relate generally to a vehicle suspension modification system.

### BACKGROUND

Two-wheeled motor vehicles, such as motorcycles, scooters, and mopeds, are popular modes of transportation known for their agility, compact size, and fuel efficiency. These vehicles are widely used for commuting, recreation, and competitive sports. Regardless of their specific configuration, two-wheeled motor vehicles generally incorporate a frame structure, steering mechanism, braking system, and a powertrain, along with components that enhance rider comfort, control, and safety.

The suspension system of a two-wheeled motor vehicle serves to absorb shocks and vibrations caused by irregularities in the riding surface, thereby improving ride quality, handling, and stability. A typical suspension arrangement includes a front fork assembly, which often utilizes telescopic tubes or similar linkages to dampen vertical movement, and a rear suspension, which may employ swingarms with coil springs, hydraulic dampers, or other resilient elements. In some configurations, the rear suspension may have a fixed geometry with no movable damping components, resulting in a rigid connection between the rear wheel and the frame. These systems are engineered to maintain optimal tire contact with the road surface, enhance traction, and reduce rider fatigue by minimizing the transmission of impacts to the frame.

### SUMMARY

Apparatus and associated methods relate to a motor vehicle suspension lowering apparatus and system. In an illustrative example, the motor vehicle suspension lowering apparatus may, for example, include one or more curved mounting brackets. The one or more curved mounting brackets may, for example, operatively couple an existing rear suspension and shock mounts of a motor vehicle via fastening elements. The one or more curved mounting brackets may, for example, operatively couple one or more linking brackets via fastening elements inserted into corresponding predetermined apertures on both the one or more linking brackets and the one or more mounting brackets. Various embodiments may advantageously alter a geometry of an existing rear suspension of a motor vehicle to selectively lower a rear ride height of the motor vehicle.

Various embodiments may achieve one or more advantages. For example, some embodiments may advantageously provide a motor vehicle rear suspension lowering system where no welding or permanent modification is required. Some implementations may, for example, advantageously enhance accessibility to a motor vehicle for shorter riders. Some embodiments may, for example, advantageously improve control and stability of a motor vehicle during training to ride the motor vehicle. Some implementations may, for example, advantageously provide a motor vehicle rear suspension lowering system with a simple installation method. Some embodiments may, for example, advantageously use durable material to ensure long-term reliability.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary motor vehicle suspension lowering system (MVSLS).

Like reference symbols in the various drawings indicate like elements.

### DETAILED DESCRIPTION OF ILLUSTRATIVE EMBODIMENTS

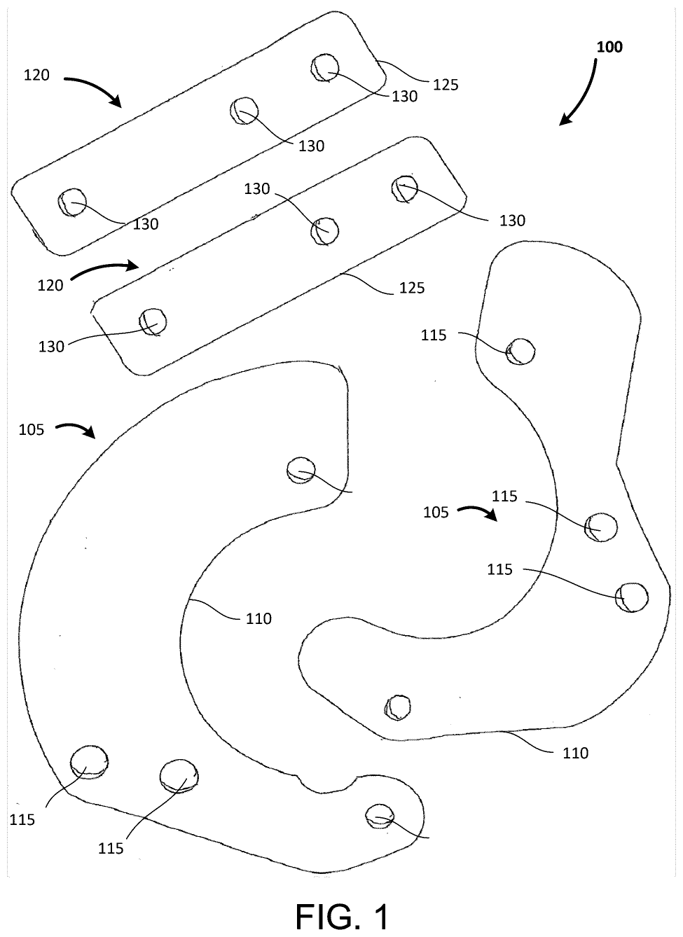

To aid understanding, this document is organized as follows. First, to help introduce discussion of various embodiments, a motor vehicle suspension lowering system (MVSLS) is introduced with reference to FIG. 1. Finally, the document discusses further embodiments, exemplary applications and aspects relating to a MVSLS.

FIG. 1 depicts an exemplary motor vehicle suspension lowering system (MVSLS) 100. The MVSLS 100 may, for example, advantageously modify a geometry of an existing rear suspension of a motor vehicle to achieve a lowered rear ride height. The MVSLS 100 may, for example, advantageously improve accessibility, control, and rider comfort, particularly for younger or shorter riders of motor vehicles. The MVSLS 100 may, for example, operatively couple a motor vehicle. By way of example, and not limitation, the motor vehicle may include a two-wheeled motor vehicle. By way of example, and not limitation, the motor vehicle may include a motorcycle. By way of example, and not limitation, the motor vehicle may include a Yamaha PW50.

The MVSLS 100 may, for example, include one or more mounting brackets 105. The one or more mounting brackets 105 may, for example, include a curved body 110. The curved body 110 may, for example, include one or more predetermined apertures 115 positioned at predetermined locations along the curved body 110.

The MVSLS 100 may, for example, include fastening elements (not depicted). The fastening elements may, for example, include bolts. The fastening elements may, for example, include screws. The fastening elements may, for example, include nuts and studs. The fastening elements may, for example, include clamps. The fastening elements may, for example, include pins. The fastening elements may, for example, include washers. The fastening elements may, for example, include spacers.

At least one of the one or more predetermined apertures 115 may, for example, be configured to align with mounting points on a motor vehicle. For example, the mounting points may include a position on the motor vehicles frame. For example, the mounting points may include an existing rear suspension and shock mounts of the motor vehicle. A user of the MVSLS 100 may, for example, operatively couple the one or more mounting brackets 105 to the motor vehicle via placing fastening elements through at least one of the one or more predetermined apertures 115 and into a mounting point on a motor vehicle. The one or more mounting brackets 105 may, for example, advantageously enable the MVSLS 100 to snuggly fit on the motor vehicle and maintain the structural integrity of the motor vehicle while enabling repositioning of the motor vehicle's existing rear suspension and shock mounts.

The MVSLS 100 may, for example, include one or more linking brackets 120. The one or more linking brackets 120 may, for example, include a body 125. The body 125 may, for example, include one or more predetermined apertures 130 positioned at predetermined locations along the body 125. The one or more predetermined apertures 130 may, for example, advantageously enable the one or more linking brackets 120 to operatively couple the one or more mounting brackets 105. The one or more linking brackets 120 may, for example, operatively couple the one or more mounting brackets 105 via fastening elements.

The predetermined locations of the one or more predetermined apertures 130 may, for example, correspond with the predetermined positions of the one or more predetermined apertures 115 such that when the one or more predetermined apertures 130 overlay the one or more predetermined apertures 115, then the one or more predetermined apertures 130 and the one or more predetermined apertures 115 form one or more selectable mounting positions. For example, a user of the MVSLS 100 may select at least one of the one or more mounting positions by matching apertures (e.g., one or more predetermined apertures 130 and one or more predetermined apertures 115) on the one or more linking brackets 120 with those on the one or more mounting brackets 105. This alignment may, for example, advantageously determine a new attachment point for a rear suspension of a motor vehicle. For example, if a shock absorber is mounted to the lowest aperture pair, then that would provide a larger lowering of the rear ride height than if a shock absorber were mounted to a higher aperture pair. The one or more selectable mounting positions may, for example, include a configuration that lowers a rear suspension by approximately 2½ inches. The one or more selectable mounting positions may, for example, include a configuration that lowers the rear suspension by approximately 1 inch. Once a desired configuration is selected, the one or more linking brackets 120 may, for example, be operatively coupled to the one or more mounting brackets 105 via fastening elements. This operative coupling may, for example, advantageously alter the angle and position of the rear shock absorber, effectively changing the rear suspension geometry.

In some embodiments, the one or more mounting brackets 105 may be made from steel plates. In some embodiments, the one or more linking brackets 120 may be made of steel plates.

Although various embodiments have been described with reference to the figures, other embodiments are possible.

Although an exemplary system has been described with reference to FIG. 1, other implementations may be deployed in other industrial, scientific, medical, commercial, and/or residential applications.

In industrial settings, the MVSLS 100 could be adapted for use in small utility vehicles, factory transport carts, or robotic platforms to provide adjustable ride height to navigate uneven surfaces or loading docks. The MVSLS 100 may, for example, advantageously quickly alter suspension geometry without permanent modifications making it ideal for environments where equipment is reconfigured frequently to meet changing operational demands.

In medical transport or rehabilitation devices, such as powered wheelchairs or mobile patient lifts, the MVSLS 100 can improve comfort and accessibility. The MVSLS 100 may, for example, advantageously enable caregivers to tailor equipment height for easier patient transfers, while also enhancing maneuverability in tight clinical spaces without compromising safety or structural integrity.

the MVSLS 100 may, for example, be employed in commercial delivery scooters, warehouse mobility units, and/or recreational rental vehicles to advantageously accommodate varying rider weights, cargo loads, or terrain types. The MVSLS 100 may, for example, advantageously offer a cost-effective way to retrofit existing fleets with adjustable ride height options, improving user experience and reducing wear on components.

For personal-use vehicles like children's motorcycles, electric scooters, or DIY mobility projects, the MVSLS 100 may, for example, advantageously provide a safe and accessible way to tailor ride height for different users. Parents or hobbyists may, for example, advantageously easily adjust the setup as children grow or as riding conditions change, without needing specialized tools or permanent alterations.

In some aspects, the techniques described herein relate to a motor vehicle suspension lowering apparatus including: one or more mounting brackets configured to operatively couple an existing rear suspension and shock mounts of a motor vehicle, the one or more mounting brackets including: a curved body; and, one or more apertures at predetermined positions along the curved body; and, one or more linking brackets including: a body; and, one or more apertures at predetermined positions along the body, wherein the predetermined positions of the one or more apertures along the body of the one or more linking brackets correspond with the predetermined positions of the one or more apertures along the curved body of the one or more mounting brackets to form one or more selectable mounting positions, wherein the one or more apertures along the body of the one or more linking brackets and the one or more apertures along the curved body of the one or more mounting brackets are configured to be operatively coupled to each other at the one or more selectable mounting positions, wherein, the operative coupling of the one or more mounting brackets and the one more linking brackets at at least one of the one or more selectable mounting positions alters a geometry of the existing rear suspension to lower a rear ride height of the motor vehicle.

In some aspects, the techniques described herein relate to an apparatus, wherein the one or more mounting brackets and the one or more linking brackets are steel flat plates.

In some aspects, the techniques described herein relate to an apparatus, wherein the one or more selectable mounting positions further include a first configuration that lowers the rear suspension by approximately 2½ inches and a second configuration that lowers the rear suspension by approximately 1 inch.

In some aspects, the techniques described herein relate to an apparatus, wherein the operative coupling of the one or more mounting brackets and the one more linking brackets at at least one of the one or more selectable mounting positions alters an angle of one or more stock rear shock absorbers of the motor vehicle.

In some aspects, the techniques described herein relate to an apparatus, wherein the motor vehicle further includes a two-wheeled motor vehicle.

In some aspects, the techniques described herein relate to an apparatus, wherein the two-wheeled motor vehicle further includes a motorcycle.

In some aspects, the techniques described herein relate to an apparatus, wherein the two-wheeled motor vehicle further includes a Yamaha PW50.

In some aspects, the techniques described herein relate to a motor vehicle suspension lowering system including: one or more motor vehicle suspension lowering apparatuses including: one or more mounting brackets configured to operatively couple an existing rear suspension and shock mounts of a motor vehicle, the one or more mounting brackets including: a curved body; and, one or more apertures at predetermined positions along the curved body; and, one or more linking brackets including: a body; and, one or more apertures at predetermined positions along the body, wherein the predetermined positions of the one or more apertures along the body of the one or more linking brackets correspond with the predetermined positions of the one or more apertures along the curved body of the one or more mounting brackets to form one or more selectable mounting positions, wherein the one or more apertures along the body of the one or more linking brackets and the one or more apertures along the curved body of the one or more mounting brackets are configured to be operatively coupled to each other at the one or more selectable mounting positions, wherein, the operative coupling of the one or more mounting brackets and the one more linking brackets at at least one of the one or more selectable mounting positions alters a geometry of the existing rear suspension to lower a rear ride height of the motor vehicle; and, one or more fastening elements configured to operatively couple the one or more mounting brackets to the one or more linking brackets at the one or more selectable mounting positions.

In some aspects, the techniques described herein relate to a system, wherein the one or more mounting brackets and the one or more linking brackets are steel flat plates.

In some aspects, the techniques described herein relate to a system, wherein the one or more selectable mounting positions further include a first configuration that lowers the rear suspension by approximately 2½ inches and a second configuration that lowers the rear suspension by approximately 1 inch.

In some aspects, the techniques described herein relate to a system, wherein the operative coupling of the one or more mounting brackets and the one more linking brackets at at least one of the one or more selectable mounting positions alters an angle of one or more stock rear shock absorbers of the motor vehicle.

In some aspects, the techniques described herein relate to a system, wherein the motor vehicle further includes a two-wheeled motor vehicle.

In some aspects, the techniques described herein relate to a system, wherein the two-wheeled motor vehicle further includes a motorcycle.

In some aspects, the techniques described herein relate to a system, wherein the two-wheeled motor vehicle further includes a Yamaha PW50.

In some aspects, the techniques described herein relate to a motor vehicle suspension lowering apparatus including: one or more motor vehicle suspension lowering apparatuses including: one or more mounting brackets configured to operatively couple an existing rear suspension and shock mounts of a motor vehicle, the one or more mounting brackets including: a curved body; and, one or more apertures at predetermined positions along the curved body; and, one or more linking brackets including: a body; and, one or more apertures at predetermined positions along the body, wherein the predetermined positions of the one or more apertures along the body of the one or more linking brackets correspond with the predetermined positions of the one or more apertures along the curved body of the one or more mounting brackets to form one or more selectable mounting positions, wherein the one or more apertures along the body of the one or more linking brackets and the one or more apertures along the curved body of the one or more mounting brackets are configured to be operatively coupled to each other at the one or more selectable mounting positions, wherein, the operative coupling of the one or more mounting brackets and the one more linking brackets at at least one of the one or more selectable mounting positions alters a geometry of the existing rear suspension to lower a rear ride height of the motor vehicle; and, means for operatively coupling the one or more mounting brackets to the one or more linking brackets at the one or more selectable mounting positions.

In some aspects, the techniques described herein relate to an apparatus, wherein the one or more mounting brackets and the one or more linking brackets are steel flat plates.

In some aspects, the techniques described herein relate to an apparatus, wherein the one or more selectable mounting positions further include a first configuration that lowers the rear suspension by approximately 2½ inches and a second configuration that lowers the rear suspension by approximately 1 inch.

In some aspects, the techniques described herein relate to an apparatus, wherein the operative coupling of the one or more mounting brackets and the one more linking brackets at at least one of the one or more selectable mounting positions alters an angle of one or more stock rear shock absorbers of the motor vehicle.

In some aspects, the techniques described herein relate to an apparatus, wherein the motor vehicle further includes a two-wheeled motor vehicle.

In some aspects, the techniques described herein relate to an apparatus, wherein the two-wheeled motor vehicle further includes a Yamaha PW50.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A motor vehicle suspension lowering apparatus comprising:
one or more mounting brackets configured to operatively couple an existing rear suspension and shock mounts of a motor vehicle, the one or more mounting brackets comprising:
a curved body; and,
one or more apertures at predetermined positions along the curved body; and,
one or more linking brackets comprising:
a body; and,
one or more apertures at predetermined positions along the body,
wherein the predetermined positions of the one or more apertures along the body of the one or more linking brackets correspond with the predetermined positions of the one or more apertures along the curved body of the one or more mounting brackets to form one or more selectable mounting positions,
wherein the one or more apertures along the body of the one or more linking brackets and the one or more apertures along the curved body of the one or more mounting brackets are configured to be operatively coupled to each other at the one or more selectable mounting positions,
wherein, the operative coupling of the one or more mounting brackets and the one more linking brackets at at least one of the one or more selectable mounting positions alters a geometry of the existing rear suspension to lower a rear ride height of the motor vehicle.

2. The apparatus of claim 1, wherein the one or more mounting brackets and the one or more linking brackets are steel flat plates.

3. The apparatus of claim 1, wherein the one or more selectable mounting positions further comprise a first configuration that lowers the rear suspension by approximately 2½ inches and a second configuration that lowers the rear suspension by approximately 1 inch.

4. The apparatus of claim 1, wherein the operative coupling of the one or more mounting brackets and the one more linking brackets at at least one of the one or more selectable mounting positions alters an angle of one or more stock rear shock absorbers of the motor vehicle.

5. The apparatus of claim 1, wherein the motor vehicle further comprises a two-wheeled motor

6. The apparatus of claim 5, wherein the two-wheeled motor vehicle further comprises a motorcycle.

7. The apparatus of claim 5, wherein the two-wheeled motor vehicle further comprises a Yamaha PW50.

8. A motor vehicle suspension lowering system comprising:
one or more motor vehicle suspension lowering apparatuses comprising:
one or more mounting brackets configured to operatively couple an existing rear suspension and shock mounts of a motor vehicle, the one or more mounting brackets comprising:
a curved body; and,
one or more apertures at predetermined positions along the curved body; and,
one or more linking brackets comprising:
a body; and,
one or more apertures at predetermined positions along the body,
wherein the predetermined positions of the one or more apertures along the body of the one or more linking brackets correspond with the predetermined positions of the one or more apertures along the curved body of the one or more mounting brackets to form one or more selectable mounting positions,
wherein the one or more apertures along the body of the one or more linking brackets and the one or more apertures along the curved body of the one or more mounting brackets are configured to be operatively coupled to each other at the one or more selectable mounting positions,
wherein, the operative coupling of the one or more mounting brackets and the one more linking brackets at at least one of the one or more selectable mounting positions alters a geometry of the existing rear suspension to lower a rear ride height of the motor vehicle; and,
one or more fastening elements configured to operatively couple the one or more mounting brackets to the one or more linking brackets at the one or more selectable mounting positions.

9. The system of claim 8, wherein the one or more mounting brackets and the one or more linking brackets are steel flat plates.

10. The system of claim 8, wherein the one or more selectable mounting positions further comprise a first configuration that lowers the rear suspension by approximately 2½ inches and a second configuration that lowers the rear suspension by approximately 1 inch.

11. The system of claim 8, wherein the operative coupling of the one or more mounting brackets and the one more linking brackets at at least one of the one or more selectable mounting positions alters an angle of one or more stock rear shock absorbers of the motor vehicle.

12. The system of claim 8, wherein the motor vehicle further comprises a two-wheeled motor vehicle.

13. The system of claim 12, wherein the two-wheeled motor vehicle further comprises a motorcycle.

14. The system of claim 12, wherein the two-wheeled motor vehicle further comprises a Yamaha PW50.

15. A motor vehicle suspension lowering apparatus comprising:
one or more motor vehicle suspension lowering apparatuses comprising:
one or more mounting brackets configured to operatively couple an existing rear suspension and shock mounts of a motor vehicle, the one or more mounting brackets comprising:
a curved body; and,
one or more apertures at predetermined positions along the curved body; and,
one or more linking brackets comprising:
a body; and,
one or more apertures at predetermined positions along the body,
wherein the predetermined positions of the one or more apertures along the body of the one or more linking brackets correspond with the predetermined positions of the one or more apertures along the curved body of the one or more mounting brackets to form one or more selectable mounting positions,
wherein the one or more apertures along the body of the one or more linking brackets and the one or more apertures along the curved body of the one or more mounting brackets are configured to be operatively coupled to each other at the one or more selectable mounting positions,
wherein, the operative coupling of the one or more mounting brackets and the one more linking brackets at at least one of the one or more selectable mounting positions alters a geometry of the existing rear suspension to lower a rear ride height of the motor vehicle; and,
means for operatively coupling the one or more mounting brackets to the one or more linking brackets at the one or more selectable mounting positions.

16. The apparatus of claim 15, wherein the one or more mounting brackets and the one or more linking brackets are steel flat plates.

17. The apparatus of claim 15, wherein the one or more selectable mounting positions further comprise a first configuration that lowers the rear suspension by approximately 2½ inches and a second configuration that lowers the rear suspension by approximately 1 inch.

18. The apparatus of claim 15, wherein the operative coupling of the one or more mounting brackets and the one more linking brackets at at least one of the one or more selectable mounting positions alters an angle of one or more stock rear shock absorbers of the motor vehicle.

19. The apparatus of claim 15, wherein the motor vehicle further comprises a two-wheeled motor vehicle.

20. The apparatus of claim 19, wherein the two-wheeled motor vehicle further comprises a Yamaha PW50.
